(19) United States
(12) Patent Application Publication
(10) Pub. No.: US 2004/0159524 A1
(43) Pub. Date: Aug. 19, 2004

(54) Cone-clutched assembly

(76) Inventors: David E. Carpenter, Skaneateles, NY (US); Timothy J. Throne, Gallatin, TN (US); Michael G. Smith, Kansas City, MO (US)

Correspondence Address: ST. ONGE STEWARD JOHNSTON & REENS, LLC, 986 BEDFORD STREET, STAMFORD, CT, 06905-5619, US

(21) Appl. No.: 10/367,084

(22) Filed: Feb. 14, 2003

(51) Int. Cl. F16D 25/0632

(52) U.S. Cl. 192/91 A; 192/66.22

(57) ABSTRACT

A cone type friction clutch has a pair of members displaceable relative to one another between an engaging position, wherein a torque is translated from a drive shaft to a crankshaft powering an air compressor, and disengaging position, wherein the drive and crank shafts are decoupled.

### FIELD OF THE INVENTION

This invention relates to a system for controllably powering at least one vehicle accessory. In particular, this invention relates to an assembly including a cone clutch which selectively provides engagement between a vehicle engine and multiple accessories including an air compressor.

### BACKGROUND OF THE INVENTION

Typically, a crankshaft of a motor vehicle simultaneously runs multiple motor vehicle rotating and reciprocating devices. However, there are numerous situations when powering one of such devices, for example an air compressor, is not necessary since the desirable air pressure in a vehicle air system has been reached. Accordingly, although the air compressor is still powered, no air is discharged under pressure until a pilot signal indicates the air pressure below a predetermined level.

The search for increasingly economical use of power in a motor vehicle has led to an engaging assembly that allows the mechanical power supplied by a crankshaft to be controllably transmitted to a variety of vehicle accessories. Utilization of such an engaging assembly allows each of the accessories to be independently powered thereby reducing fuel consumption, since each of the accessories is driven only on demand.

Known engaging assemblies employ multi-disc friction rings or plate assemblies to periodically transfer power. Multi-disc friction rings or plate assemblies utilize numerous engaging surfaces which tend to wear out. As a consequence, these types of clutches have a relatively short service life, since the entire clutch assembly is customarily replaced even if only a single plate or ring has been found damaged. Furthermore, maintenance of a clutch having such complex structures is difficult because each of the multiplicity of engaging surfaces must be closely examined for wear and damage.

U.S. Pat. No. 5,479,743 to Plantan discloses an apparatus periodically powering an air compressor by using a clutch, which selectively engages a crankshaft so that transmission of power to the crankshaft is controlled by the clutch. As a consequence, an air compressor is run on demand.

The clutch is comprised of two sets of friction plates, wherein plates of one of the sets engage plates of the other set in an engaging state of the clutch. Engagement between the plates causes the rotation of crankshaft to be translated into reciprocal motion of a compressor shaft.

U.S. Pat. No. 4,468,805 to Beaumont discloses an air compressor with a multi-disc friction ring clutch periodically engaging a crankshaft with a drive shaft. A resilient element positioned between driving and driven parts of the clutch exerts a constant thrust upon movable driven discs providing friction between the parts sufficient to drive the crankshaft. The clutch, thus, remains in an engaging position until an air pressure in a clutch exceeds the thrust to force the movable plates of the clutch out of engagement in response to reaching a predetermined pressure level in a vehicle air system.

The parts of the multi-disc friction ring and plate assemblies periodically engage one another to transfer power and consequently wear out. The clutches described in the Plantan and Beaumont patents have relatively short service lives because the entire clutch assembly must be replaced even if only a single plate or ring has been found damaged. Additionally, maintenance of a clutch having the complex structures disclosed in both of the above discussed patents is difficult because it requires that each of the multiplicity of engaging surfaces must be closely examined for wear and damage. Furthermore, these known systems do not enjoy the benefits offered by the present disclosure of a simpler structure, ease of installation and maintenance, and increased reliability in the transmission of power.

What is desired therefore is a system for controllably powering at least one vehicle accessory which provides a motor vehicle with a cone clutch assembly which is easy to install and maintain, which reliably transmits a torque generated by a drive shaft to a crankshaft powering an air compressor, which disengages a compressor from an engine drive shaft to extend the compressor's service and which provides reduced fuel consumption through selective periodic compressor use.

### SUMMARY OF THE INVENTION

Accordingly, it is an object of the invention to provide a system for controllably powering at least one vehicle accessory and in particular an assembly which includes a cone clutch which selectively provides engagement between a vehicle engine and multiple accessories including an air compressor.

It is therefore an object of this invention to provide a motor vehicle with a cone clutch assembly which is easy to install and maintain.

Still another object of the invention to provide a cone clutch assembly that reliably transmits a torque generated by a drive shaft to a crankshaft powering an air compressor.

Yet another object of the invention is to provide a motor vehicle with a cone clutch assembly that disengages a compressor from an engine drive shaft to extend the compressor's service.

Another object of the invention is to provide a motor vehicle with a cone clutch assembly that provides reduced fuel consumption through selective periodic compressor use.

These and other objects of the invention are achieved in an embodiment by provision of an

It is also preferable that the invention may provide

It is also preferable that the invention may provide

In another embodiment the objects of the invention are achieved by provision of a

It is also preferable that the invention may provide

### BRIEF DESCRIPTION OF THE PREFERRED EMBODIMENT

The above and other features, objects and advantages will become more readily apparent from a specific description of the preferred embodiment, accompanied by the following drawings, in which:

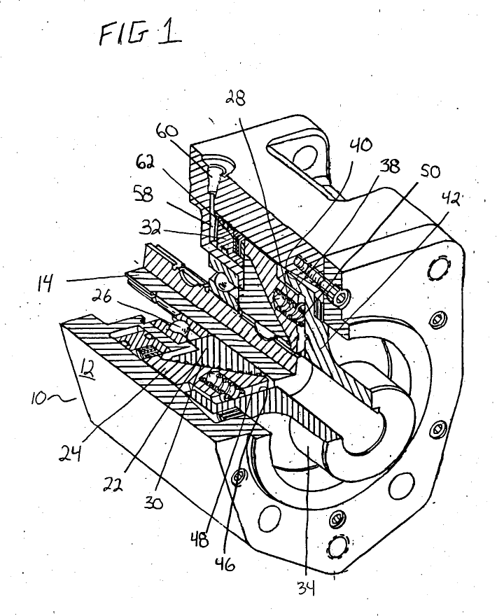

FIG. 1 is an isometric perspective cut-out view of a cone-clutch assembly.

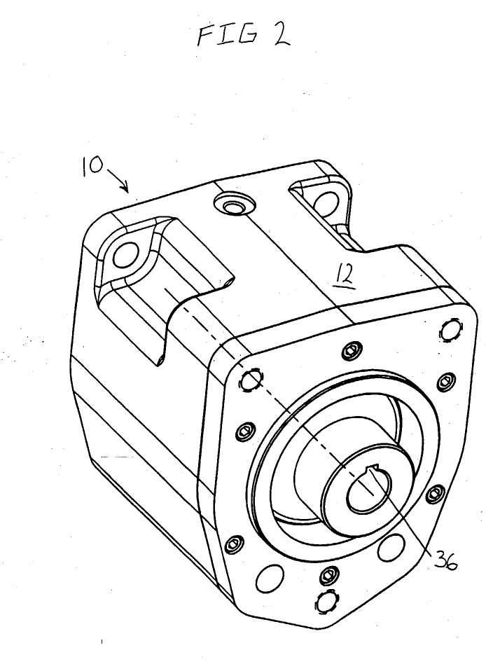

FIG. 2 is an isometric view of a cone-clutch assembly.

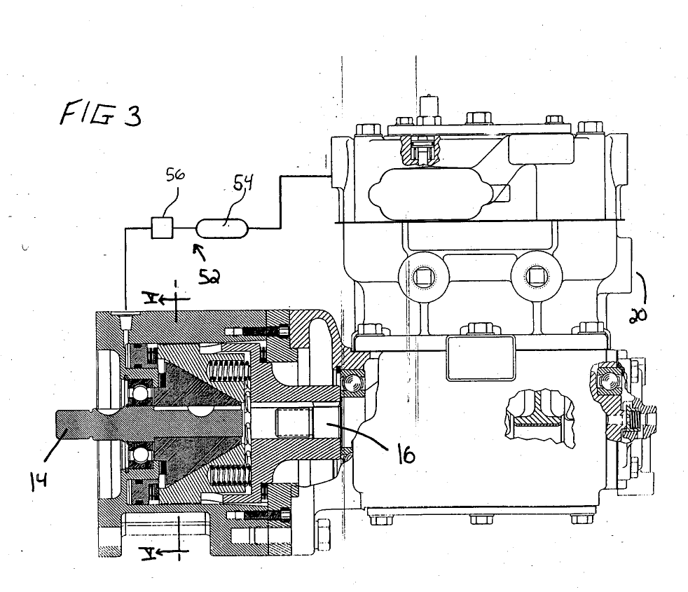

FIG. 3 is a longitudinal cross-section of an air-compressor in combination with the clutch assembly of FIG. 1

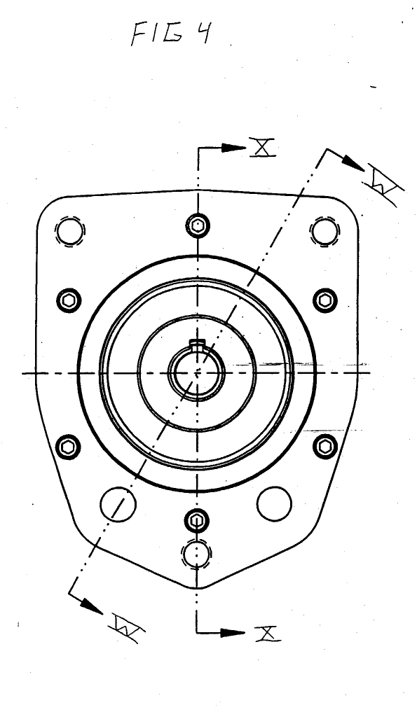

FIG. 4 is a perspective front view of a cone-clutch assembly.

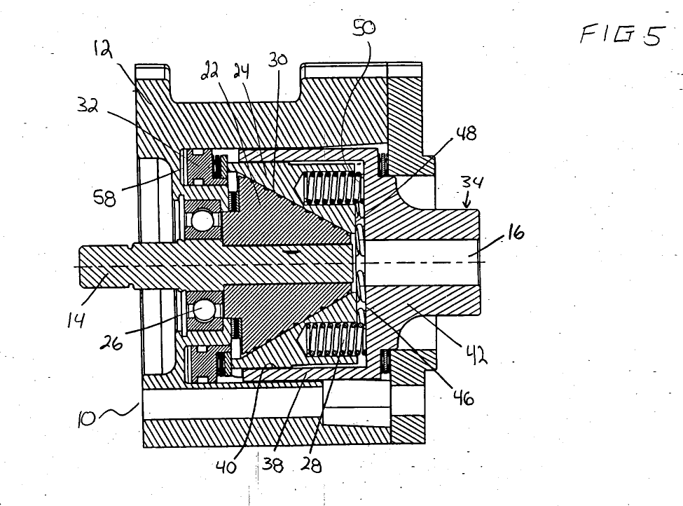

FIG. 5 is a longitudinal sectional view of the clutch assembly taken along lines W-W as illustrated in FIG. 4 showing the assembly engaged.

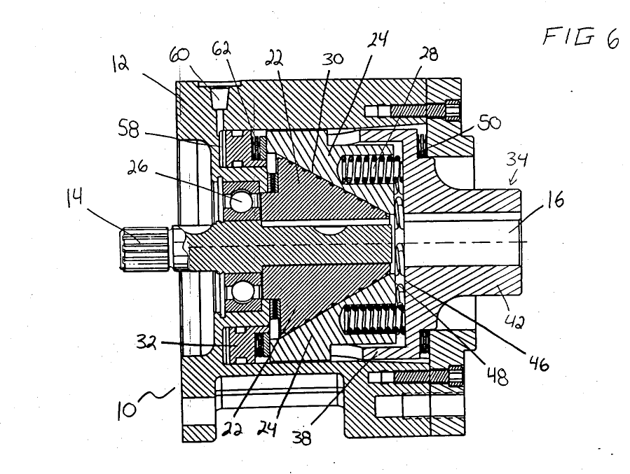

FIG. 6 is a longitudinal sectional view of the clutch assembly taken along lines X-X as illustrated in FIG. 4 showing the assembly engaged.

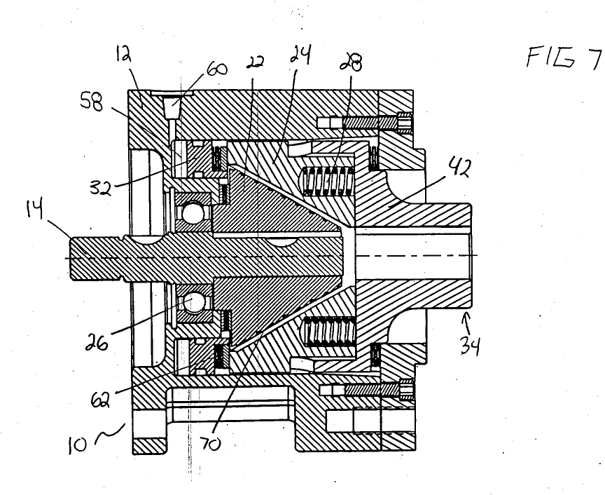

FIG. 7 is another longitudinal sectional view of the clutch assembly taken along lines X-X as illustrated in FIG. 4 showing the assembly disengaged.

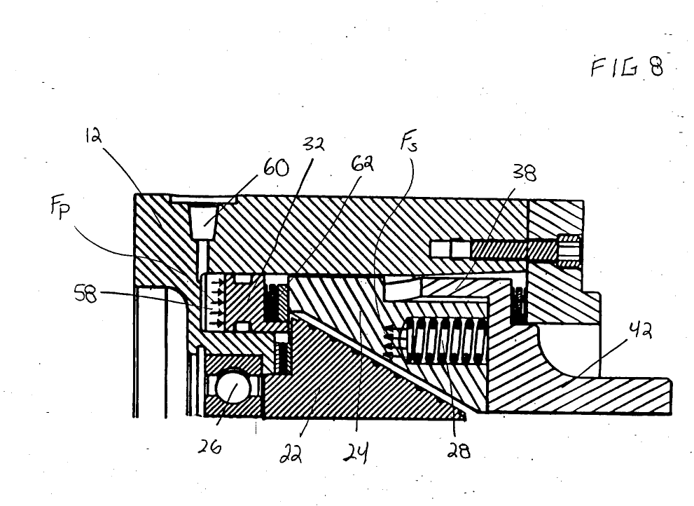

FIG. 8 is enlarged longitudinal sectional view of a portion of the clutch assembly of FIG. 7 taken along lines X-X as illustrated in FIG. 4 showing the assembly disengaged.

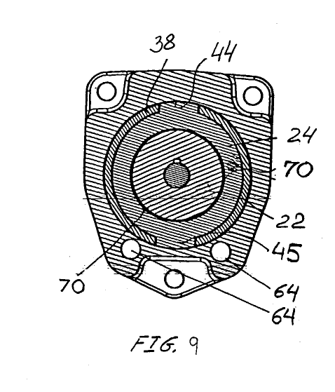

FIG. 9 is a cross sectional view of the clutch assembly taken along lines V-V as illustrated in FIG. 3.

### DETAILED DESCRIPTION OF THE DRAWINGS

FIG. 2 shows a clutch assembly 10 includes a casing 12. The clutch assembly 10 controllably transmits a rotational torque from a powered rotating shaft to an unpowered rotatable shaft. The powered shaft could be powered by various known motors or generators of torque, but in the preferred embodiment it is the drive shaft 14 of a motor vehicle. The unpowered rotable shaft is a means to transfer power to any number of accessory vehicle systems. In the illustrate embodiment, the unpowered rotable shaft is a crankshaft 16 intended to power an air compressor 20 primarily providing a vehicle-air-actuated braking system in a manner disclosed in U.S. Pat. No. 4,648,805 to Beaumont, which is fully incorporated herein by reference. FIG. 3 shows a cone clutch assembly 10 in conjunction with an air compressor 20.

The components of the clutch assembly 10 are illustrated in greater detail in the cut-out diagram provided in FIG. 1. The drive shaft 14 enters the clutch assembly 10 at on opening of the casing 12 and within the assembly 10 is rotationally fixed to a clutch member at the end of the drive shaft 14. The crank shaft 16 enters the clutch assembly 10 through a hubdrive 34 and is selectively fixed to a corresponding clutch member through a subassembly described below. While the drive shaft 14 and crank shaft 16 may be at any angle with respect to each others, in the preferred embodiment illustrated the shafts are parallel and coaxial.

Each clutch member has friction surface angled less than 90 degrees with respect to the axis of the corresponding shaft. The clutch members may be conically shaped, frustoconically shaped or any other partial conical form. The clutch assembly 10 illustrated is a cone clutch assembly having male cone clutch member 22 and female cone clutch member 24; however, it is anticipated that the powered shaft could be affixed to a female clutch member and engage a male clutch member attached to the crankshaft 16. It is also anticipated that each clutch member could be male shaped engaging each other at complimentary angles. The clutch assembly may be dry or oil immersed. The male 22 and female 24 cone members mounted in the casing 12 coaxially with the drive shaft 14. In the illustrated embodiment, the male cone member 22 is rotationally fixed to the drive shaft 14 which is continuously rotated, in use, by an engine and mounted in the casing by means of bearing ball 26.

A subassembly actuating the crankshaft 16 includes the female cone member 24, which is pre-loaded to normally engage the male cone member 22 in an engaging position, as shown in FIGS. 5-6. While a variety of pre-loading means including resilient, hydraulic and electrical elements can be implemented, this embodiment is illustrated with helical springs 28 providing an axial spring force (Fs) which biases the cone members to the engaged position. In the engaged position, the cone clutch members, extended at complementary angles, frictionally engage one another along the frictional surfaces 30.

The subassembly further has a piston 32 mounted in the casing 12 at a radial distance from the drive shaft 14 and capable of axially moving toward the female cone member 24 to provide disengagement of the clutch, as will be described below. The clutch assembly 10 is illustrated in the disengaged position in FIGS. 7-8. A hubdrive 34 spaced axially from piston 32 completes the subassembly by rotationally engaging the female cone member 24 to provide transmission of the torque through the engaged cone surfaces 30 to the crankshaft 16, which is keyed to the hubdrive at 36. The keyed section 36 of the hubdrive 34 is shown best in FIG. 2.

The hubdrive 34 is an annular element having a flange 38 radially engaging a portion of an outer surface 40 of the female cone member and an L-shaped hub 42 receiving the crankshaft 16. To provide synchronous rotation between the hubdrive 34 and the female cone member, the flange 38 is splined to have a pair of spaced apart axial grooves 44, which slidably receive tongues 45 formed on the female member, as shown best in FIG. 9. Accordingly, while the hubdrive 34 and female cone member 24 are rotationally intermeshed, these two components are axially displaceable relative to one another as the tongues 45 are guided along the grooves 44 during displacement of the female cone 24 toward and from the engaging position. Note that the axial grooves can be formed on the female cone member, whereas the inwardly extending tongues can be provided on the flange of the hubdrive.

A radially extending portion 46 of the L-shaped hub is axially spaced from a radial face 48 of the female cone at a distance sufficient for the female cone member 24 to completely withdraw from the frictional engagement with the male cone member 22. As a consequence, once the cone surfaces are totally separated, the female member stops rotating thereby preventing transmission of the torque from the drive shaft 14 to the hubdrive 34 and to the crankshaft 16.

To effectively direct the axial spring force (Fs) generated by the helical springs 28, their opposite ends are braced against a bottom of an annular axial groove 50, formed in the radial face 48 of the female cone member, and the radial portion 46 of the L-shaped portion of the hubdrive 34.

A pressure subassembly provides an air pressure force (Fp) that allows controllable disengagement for the clutch assembly 10. When a predetermined threshold air pressure is reached in the air compressor system, a signal, which may be a governor signal, is provided to disengage the clutch assembly 10. The governor signal may be electrical, servomechanical, hydraulic or by any means known in the art to effect the disengagement of the clutch assembly. The governor signal may be capable of mechanically causing the piston 32 move and the clutch to controllably disengage. However, it may be preferred that the signal comprises pressurized air, as is the case with the embodiment shown in FIGS. 1-9.

The controllable disengagement is based on the relationship between the spring force (Fs) exerted by springs 28 and the oppositely directed axial air pressure force (Fp), which is exerted upon the piston 32.

The air pressure force (Fp) is a function of a hydraulic or air system pressure 52. The air pressure force (Fp) is generated in a chamber 58 formed between the piston 32 and the casing 12, and is exerted on the piston 32. Typically, when the system pressure, which in a preferred embodiment, may corresponds to a volume of compressed medium in a reservoir 54, is equal to or below a predetermined pressure threshold, the spring force (Fs) maintains the clutch in the engaged position. Because a governor valve 56 closes the communication between the reservoir 54 and the chamber 58, the spring force (Fs) exceeds the air pressure force (Fp) in the chamber 58. Thus, the clutch assembly 10 is biased to shifting the female cone member 24 into the engaged position.

As a volume of compressed air produced by the air compressor 20 gradually increases, as the air pressure with in the system increases, the governor valve 56 opens in response to a control signal corresponding to the predetermined pressure threshold. Accordingly, communication between the chamber 58 and the reservoir 54 is established through an air/fluid port 60 and the pressure in the chamber 58 rises. Correspondingly, the air pressure force (Fp) within the chamber increases. As the air pressure force (Fp) overcomes the spring force (Fs) forcing the piston 32 to axially displace and transmitting the force through a bearing thrust assembly 62 upon the female cone member 24. In response, the female cone member is controllably displaced toward a disengaging position against the spring force (Fs) to gradually reduce the transmitted torque. The relevant forces are illustrated in FIG. 9.

Note that a control signal can correspond to a volume in the reservoir instead of being represented as a pressure signal. Overall, the transmitted torque capacity is determined by the cone angle, friction area, horizontal thrust load and, will be explained below, the friction material coefficient.

The control cycle is completed as the system pressure and volume of the pressurized medium in the reservoir drops below the predetermined threshold. As a result, the pressure in the chamber 58 gradually decreases until it is insufficient to overcome the pre-loaded spring force (Fs). Accordingly, as the system pressure decreases, the spring force (Fs) is again sufficient to move the female cone member 24 back to the engaging position to renew rotation of the crankshaft 16 powering the compressor. As a consequence, the cone surfaces 30 are again reliably engaged to transmit the rotational torque.

To facilitate disengagement between the cone surfaces, at least one of them, preferably the male cone member, has a friction material 70 (FIG. 9) including a paper compound, which may consist of fibers. Preferably the friction material is bonded to the cone face to form a lettuce pattern extending approximately at a 30° angle with respect to a longitudinal axis of the drive shaft 14. As a consequence, cooling and/or lubricating oil can run in cycles effectively treating the entire surface of the cone face. Since the disclosed clutch assembly is preferably oil immersed, the casing is provided with oil drains 64, better seen in FIG. 9.

Note that a variety of different accessories, such as pumps, can be driven by the drive shaft simultaneously with the air compressor by any feasible means mounted on an input end of the drive shaft and well known in the art.

Although the invention has been described with reference to a particular arrangement of parts, features and the like, these are not intended to exhaust all possible arrangements or features, and indeed many other modifications and variations will be ascertained by those skilled in the art.

What is claimed is:

1. A torque transmitting assembly comprising:
a rotating shaft, said rotating shaft rotating about an axis and having a friction surface fixed at an end thereof, said friction surface being angled less than 90 degrees with respect to the axis;
a rotatable shaft, said rotatable shaft being rotatable about an axis and having a friction surface fixed at an end thereof, said friction surface being angled less than 90 degrees with respect to the axis;
wherein the angled friction surface of said rotating shaft and said angled friction surface of said rotatable shaft are movable relative to each other in response to a level of pressurized air, between an engaged position wherein said angled friction surface of said rotating shaft and said angled friction surface of said rotatable shaft contact each other and said rotating shaft causes said rotatable shaft to rotate and a disengaged position wherein said angled friction surface of said rotating shaft and said angled friction surface of said rotatable shaft are not in contact or only in incidental contact wherein substantially no torque is transmitted to said rotatable shaft.

2. The assembly defined in claim 1 wherein said rotating shaft and said rotatable shaft are biased toward said engaged position.

3. The assembly defined in claim 2 wherein said rotating shaft and said rotatable shaft are movable against said bias, into said disengaged position.

4. The assembly defined in claim 3 wherein said rotating shaft and said rotatable shaft are movable against said bias in response to a level of pressurized air.

5. The assembly defined in claim 1 wherein the axis about which said rotating shaft is rotatable and the axis about which said rotatable shaft is rotatable are parallel.

6. The assembly defined in claim 5 wherein the axis about which said rotating shaft is rotatable and the axis about which said rotatable shaft is rotatable are coaxial.

7. The assembly defined in claim 6 wherein the angled friction surface of said rotating shaft forms a male cone friction surface and said angled friction surface of said rotatable shaft forms a female cone friction surface.

8. A torque transmitting assembly for powering an air compressor comprising:
a rotating shaft, said rotating shaft rotating about an axis and having a friction surface fixed at an end thereof, said friction surface being angled less than 90 degrees with respect to the axis;
a rotatable shaft, said rotatable shaft being rotatable about an axis and having a friction surface fixed at an end thereof, said friction surface being angled less than 90 degrees with respect to the axis;
wherein the angled friction surface of said rotating shaft and said angled friction surface of said rotatable shaft are movable relative to each other in response to a level of pressurized air, between an engaged position wherein said angled friction surface of said rotating shaft and said angled friction surface of said rotatable shaft contact each other and said rotating shaft causes said rotatable shaft to rotate and a disengaged position wherein said angled friction surface of said rotating shaft and said angled friction surface of said rotatable shaft are not in contact or only in incidental contact wherein no torque is transmitted to said rotatable shaft;
wherein said rotating shaft and said rotatable shaft are biased toward said engaged position;
wherein said rotating shaft and said rotatable shaft are movable against said bias, into said disengaged position;
wherein said rotating shaft and said rotatable shaft are movable against said bias in response to a level of pressurized air;

9. A torque transmitting assembly comprising:
a rotating shaft, said rotating shaft rotating about an axis and having a rotationally fixed male cone friction surface disposed at an end thereof;
a rotatable shaft, said rotatable shaft being rotating about an axis and having a rotationally fixed female cone friction surface disposed at an end thereof;
wherein the male cone friction surface of said rotating shaft and said female cone friction surface of said rotatable shaft are movable relative to each other in response to a level of pressurized air, between an engaged position wherein said male cone friction surface of said rotating shaft and said female cone friction surface of said rotatable shaft contact each other and said rotating shaft causes said rotatable shaft to rotate and a disengaged position wherein said male cone friction surface of said rotating shaft and said female cone friction surface of said rotatable shaft are not in contact or only in incidental contact wherein no torque is transmitted to said rotatable shaft.

10. The assembly defined in claim 9 wherein said rotating shaft and said rotatable shaft are biased toward said engaged position;

11. The assembly defined in claim 10 wherein said rotating shaft and said rotatable shaft are movable against said bias, into said disengaged position;

12. The assembly defined in claim 11 wherein said rotating shaft and said rotatable shaft are movable against said bias in response to a level of pressurized air;

13. A torque transmitting assembly for powering an air compressor comprising:
a rotating shaft, said rotating shaft rotating about an axis and having a rotationally fixed male cone friction surface disposed at an end thereof;
a rotatable shaft, said rotatable shaft being rotatable about an axis and having a rotationally fixed female cone friction surface disposed at an end thereof;
wherein the male cone friction surface of said rotating shaft and said female cone friction surface of said rotatable shaft are movable relative to each other in response to a level of pressurized air, between an engaged position wherein said male cone friction surface of said rotating shaft and said female cone friction surface of said rotatable shaft contact each other and said rotating shaft causes said rotatable shaft to rotate and a disengaged position wherein said male cone friction surface of said rotating shaft and said female cone friction surface of said rotatable shaft are not in contact or only in incidental contact wherein no torque is transmitted to said rotatable shaft;
wherein said rotating shaft and said rotatable shaft are biased toward said engaged position;
wherein said rotating shaft and said rotatable shaft are movable against said bias, into said disengaged position;
wherein said rotating shaft and said rotatable shaft are movable against said bias in response to a level of pressurized air;
